(19) United States
(12) Patent Application Publication
(10) Pub. No.: US 2024/0180179 A1
(43) Pub. Date: Jun. 6, 2024

(54) CONTACT DRUM FREEZER SYSTEM FOR AUTOMATED AND/OR MECHANIZED FOOD PROCESS LINES, AND PRODUCTS PRODUCED THEREBY

(71) Applicants: Robert G. Nothum, Jr., Springfield, MO (US); Ryan Doyle Nothum, Springfield, MO (US)

(72) Inventors: Robert G. Nothum, Jr., Springfield, MO (US); Ryan Doyle Nothum, Springfield, MO (US)

(21) Appl. No.: 18/388,331

(22) Filed: Nov. 9, 2023

Related U.S. Application Data
(63) Continuation-in-part of application No. 18/233,422, filed on Aug. 14, 2023.
Application No. 18/233,422 is a continuation-in-part of application No. 17/300,468, filed on Jul. 9, 2021, now abandoned.
Application No. 17/300,468 is a continuation-in-part of application No. 16/658,429, filed on Oct. 21, 2019, now abandoned.
(60) Provisional application No. 62/748,714, filed on Oct. 22, 2018.
(60) Provisional application No. 63/049,723, filed on Jul. 9, 2020.

(51) Int. Cl. A23B 4/06; F25D 13/06

(52) U.S. Cl. CPC A23B 4/062; F25D 13/062

(57) ABSTRACT

A contact drum freezer system includes a contact drum freezer, an endless product wrap belt and a cross feed conveyor. The contact drum freezer is mounted to revolve about an axis generally parallel to a main lane of transit. The endless product wrap belt has an intake shelf, an inner product-compressing run encircling most of the drum and an outer return run looping back to the intake shelf. The cross feed conveyor is situated in the main lane of transit and has a return run a and product-carrying run for transferring product laterally out of the main lane of transit and onto the intake shelf of the product wrap belt.

### CROSS-REFERENCE TO RELATED APPLICATION(S)

This application is a continuation of U.S. patent application Ser. No. 18/233,422 filed Aug. 14, 2023, which is a continuation-in-part of U.S. patent application Ser. No. 17/300,468, filed Jul. 9, 2021, which is a continuation-in-part of U.S. patent application Ser. No. 16/658,429, filed Oct. 21, 2019; which claims the benefit of U.S. Provisional Application No. 62/748,714, filed Oct. 22, 2018.

The U.S. patent application referenced above, Ser. No. 17/300,468, filed Jul. 9, 2021, claims the benefit of U.S. Provisional Application No. 63/049,723, filed Jul. 9, 2020.

The foregoing patent disclosure(s) is(are) incorporated herein by this reference thereto.

### BACKGROUND AND SUMMARY OF THE INVENTION

The invention generally relates to automated and/or mechanized food-process line equipment and, more particularly, to a contact drum freezer therefor as well as products produced thereby.

An example food product to run through a contact drum freezer could include for example and without limitation a meat patty. That is, something like a hamburger patty is relatively flattened between spaced broad sides, and the application of contact freezer service on one of the broad sides propagates freezing through the hamburger patty until solidly frozen through to the other broad side.

A shortcoming with prior art drum freezers is that the freezing service is so often only applied to one side of the food product. The freezing of the food product propagates from the side in contact with the drum to the other, far side.

It is an object of the invention to provide freeze-capable cooling service to the outside of the food product too (and not only the side of the food product in contact with the drum) so that there is a double-sided initiation and propagation of freezing through the food product.

It is another object of the invention to accomplish, through the passage of one machine, the lateral compression of a compressively-yielding food product (eg, whole peeled bananas or pieces thereof) as well bi-lateral service to the compressed food product of below-freezing temperatures.

As an aside, the temperature of ‘freezing temperature’ is a relative term in view of the specific food product. The reported freezing temperature for fresh water is thirty-two degrees Fahrenheit, zero degrees Celsius. And while bananas would no doubt require a lower temperature to freeze, for food product safety, it is desirable to go way below the minimum required temperature, to perhaps forty degrees below zero Fahrenheit (forty degrees below zero Celsius).

A number of additional features and objects will be apparent in connection with the following discussion of the preferred embodiments and examples with reference to the drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a front perspective view of the infeed/outflow side of a contact drum freezer system in accordance with the invention for automated and/or mechanized food process lines, or more particularly, this FIG. 1 for the most part shows the two sections of the bifurcated housing (cabinets and hoods) therefor slid/moved SHUT (wherein the respective hood portions for each of the two housing sections are lowered CLOSED, on their respective cabinets, and the two housing sections are slid/moved laterally SHUT with respect to each other);

FIG. 2 is an enlarged-scale perspective view of the drum as well as the endless belt therefor, both in accordance with the invention, and shown fully in isolation of the housing sections and also shown about nearly in isolation from all the supporting sub-systems therefor;

FIG. 3 is an enlarged-scale perspective view taken in the direction of arrows III-III in FIG. 1, in which the hoods are removed from view (as well as the near sidewall of the near cabinet) to better show the drum and endless belt as well as to better show portions of the supporting sub-systems therefor;

FIG. 4 is a section view taken along line IV-IV in FIG. 3;

FIG. 5 is a perspective view comparable to FIG. 1 except from a vantage point about ninety degrees (90°) counterclockwise (about a quarter of way of circling around the machine to the right in FIG. 1), wherein the pair of housing sections are slid/moved laterally APART, the nearer section comprises the INSIDE treatment housing section and its hood is elevated OPENED, and the further section comprises the OUTSIDE treatment housing section and its hood remains lowered CLOSED;

FIG. 6 is an enlarged-scale perspective view of the OUTSIDE treatment housing section of FIG. 5 in isolation;

FIG. 7 is an enlarged-scale perspective view of detail VII-VII in FIG. 6;

FIG. 8 is an enlarged-scale perspective view of detail VIII-VIII in FIG. 9;

FIG. 9 is a section view taken along line IX-IX in FIG. 6;

FIG. 10 is a section view taken along line X-X in FIG. 1;

FIG. 11 is a section view taken along line XI-XI in FIG. 10;

FIG. 12 is a section view comparable to FIG. 11 except wherein the drum has rotated forty-five degrees (45°) clockwise;

FIG. 13 is an enlarged-scale perspective view of detail XIII-XIII in FIG. 10;

FIG. 14 is an enlarged-scale perspective view of detail XIV-XIV in FIG. 10;

FIG. 15 is a section view taken along line XV-XV in FIG. 14;

FIG. 16 is a perspective view comparable to FIG. 5 except not only with the housing sections removed from view but also from a vantage point about one-hundred and eighty degrees (180°) counterclockwise (on the opposite side of the machine from FIG. 5) to show better how there is a service of an external chiller providing chilled refrigerant to the D'Limonene loops inside the machine and serving both the INSIDE treatment systems (with which the emphasis is on the drum) as well as the OUTSIDE treatment systems (with which the emphasis is on the air-knives directing freezing-temperature air onto the outside of the solid stainless endless wrapping belt);

FIGS. 17A-17C comprise a set of perspective views of an exemplary food product for freezing by the contact drum freezer system in accordance with the invention, wherein:

FIG. 17A is a perspective view of a fresh in-the-peel banana, with the peel being partly opened at the stem end;

FIG. 17B is a perspective view of a fresh, peeled banana with potential slice lines indicated in dashed lines providing suggestions, if it were desirable to reduce the whole banana down into pieces thereof, where such slices can be made; and

FIG. 17C is a perspective view showing that the exemplary food product for freezing by the contact drum freezer system in accordance with the invention might comprise any of:
a whole peeled banana,
halves of a peeled banana, or
sliced chips of a peeled banana;

FIG. 18 is a perspective view comparable to FIG. 2 showing the infeed and outflow of whole peeled bananas through the contact drum freezer system in accordance with the invention;

FIG. 19 is an enlarged-scale perspective view of detail XIX-XIX in FIG. 18;

FIG. 20 is a re-production of FIG. 4 from one of the priority provisional applications hereof, U.S. Provisional Application No. 63/049,723, filed Jul. 9, 2020—Robert G. Nothum, Jr.—entitled: COMPRESSED FROZEN BANANA PRODUCT AND PRODUCTION, wherein the reference numerals in the original FIG. 4 have been erased and in this new re-production as FIG. 20 has been given reference numerals consonant with FIGS. 1-19 hereof;

FIG. 21 is a perspective view of the outside of the housing showing the electric-powered drive motor for the water wheel and the electric-powered drive motor for the drum;

FIG. 22 is a top plan view of FIG. 21 again showing the outside of the housing as well as the electric-powered drive motor for the water wheel and the electric-powered drive motor for the drum and further showing the chain drive between (1) the drive sprocket turned by the electric-powered drive motor for the drum and (2) the enlarged driven sprocket that turns the drum at a substantially turned down speed ratio (ie., reduced rate of revolutions ratio);

FIG. 23 is a perspective view of the outside of the housing showing the electric-powered drive motor for the belt;

FIG. 24 is an elevation view of the outside of the housing which not only shows the electric-powered drive motor for the water wheel and the electric-powered drive motor for the drum, but also shows the electric-powered drive motor for the D'Limonene flow that loops through the air chillers the electric-powered drive motor for D'Limonene flow that loops through the drum including being slung out by the slingers inside the drum;

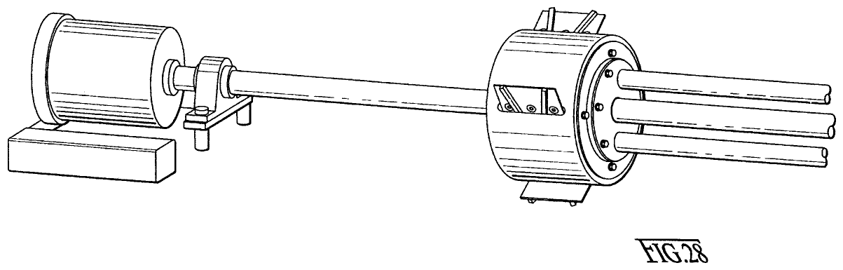

FIGS. 21A, 22A, 23A, 24A and 25-31 represent power sources for the Drum, Water Wheel, Slinger, Belt and two pump motors, wherein:

FIG. 21A is a perspective view of an electric-motor powered chain drive for the Drum;

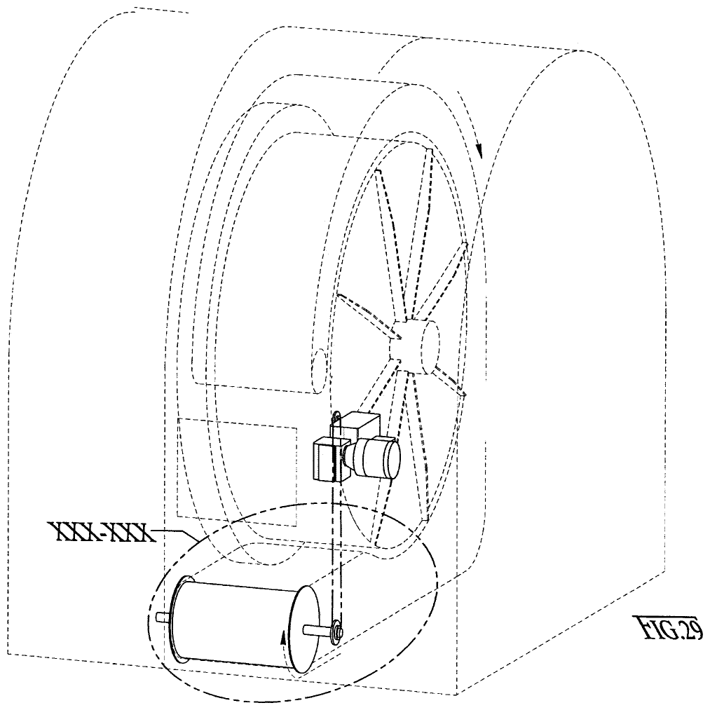

FIG. 22A is an enlarged-scale perspective view of detail XXIIA-XXIIA in FIG. 21A;

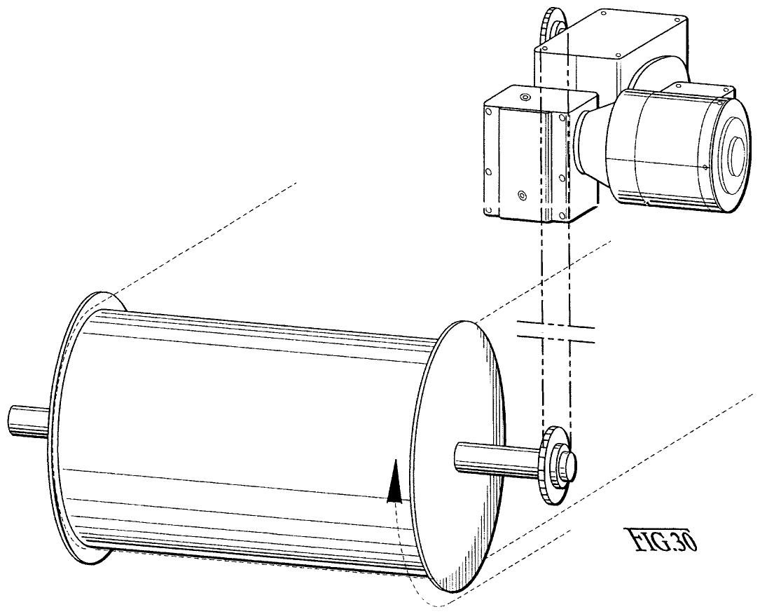

FIG. 23A is a perspective view comparable to FIG. 21A except showing just the Drum and electric motor therefor with the chain drive and support framework removed from view;

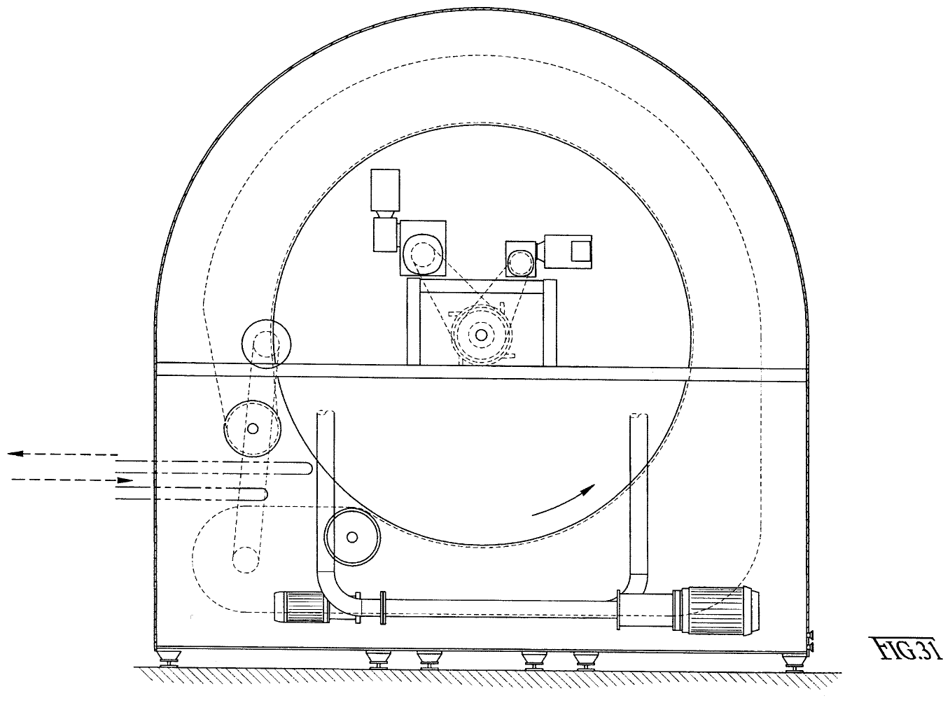

FIG. 24A is an enlarged-scale perspective view of detail XXIVA-XXIVA in FIG. 23A;

FIG. 25 is a perspective view of an electric-motor powered chain drive for the Water Wheel;

FIG. 26 is an enlarged-scale perspective view of detail XXVI-XXVI in FIG. 25;

FIG. 27 is a perspective view of an electric-motor powered direct drive for the Slinger;

FIG. 28 is an enlarged-scale perspective view of detail XXVIII-XXVIII in FIG. 25;

FIG. 29 is a perspective view of an electric-motor powered chain drive or alternatively a V-belt/pulley drive for the Belt;

FIG. 30 is an enlarged-scale perspective view of detail XXX-XXX in FIG. 29; and

FIG. 31 is a perspective view of an electric-motor powered coolant pumps, one for circulating coolant through an INSIDE treatment system and another for OUTSIDE treatment system an INSIDE treatment system.

### DETAILED DESCRIPTION OF THE PREFERRED EMBODIMENTS

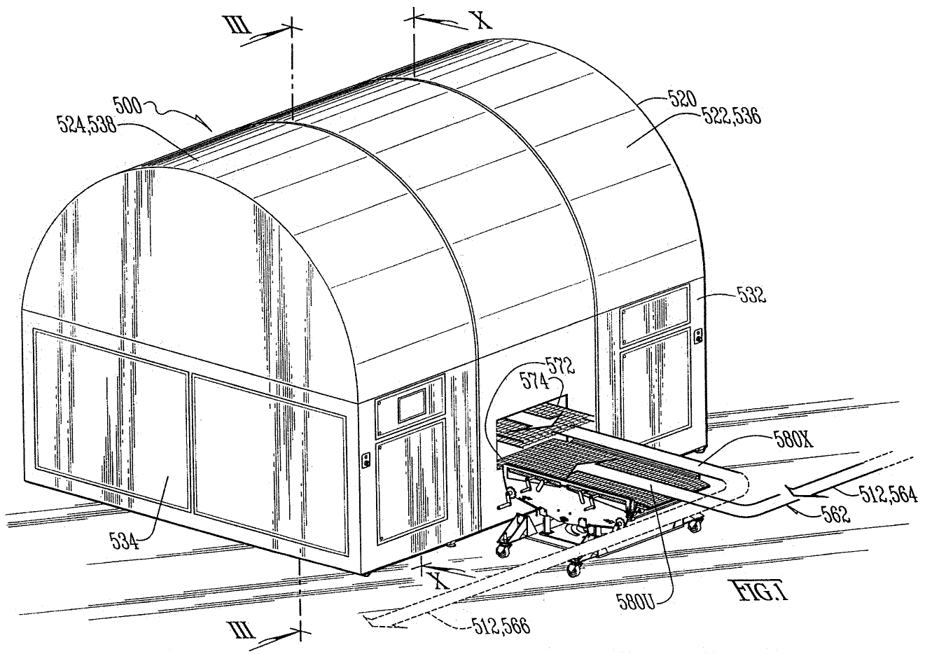

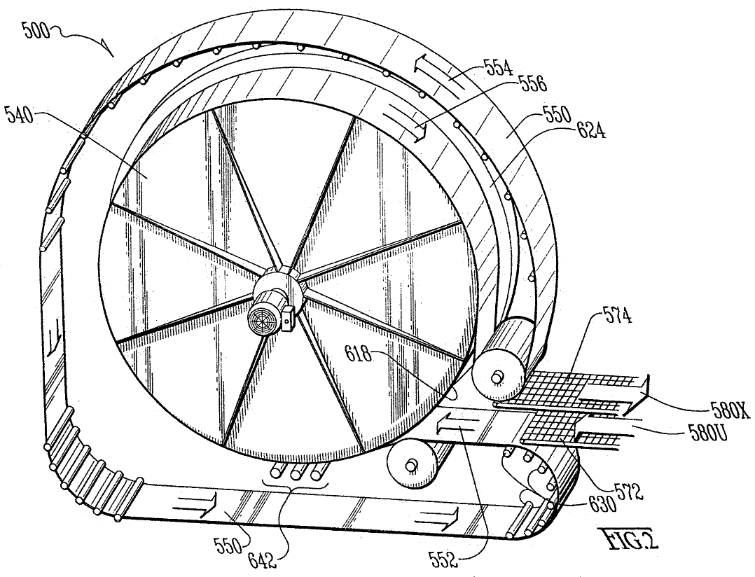

FIG. 1 shows the infeed/outflow side (eg., the side of transfer, or infeed and outflow conveyors 572 and 574 described more particularly below) of a contact drum freezer system 500 in accordance with the invention for automated and/or mechanized food process lines 512. More particularly, this FIG. 1 for the most part shows the two sections 522 and 524 of the bifurcated housing 520 (cabinets 532 and 534 and hoods 536 and 538) therefor slid/moved SHUT. That is, the respective hood portions 536 and 538 for each of the two housing sections 522 and 524 are lowered CLOSED on their respective cabinets 532 and 534. And the two housing sections 522 and 524 (cabinet and hood) are slid/moved laterally SHUT with respect to each other.

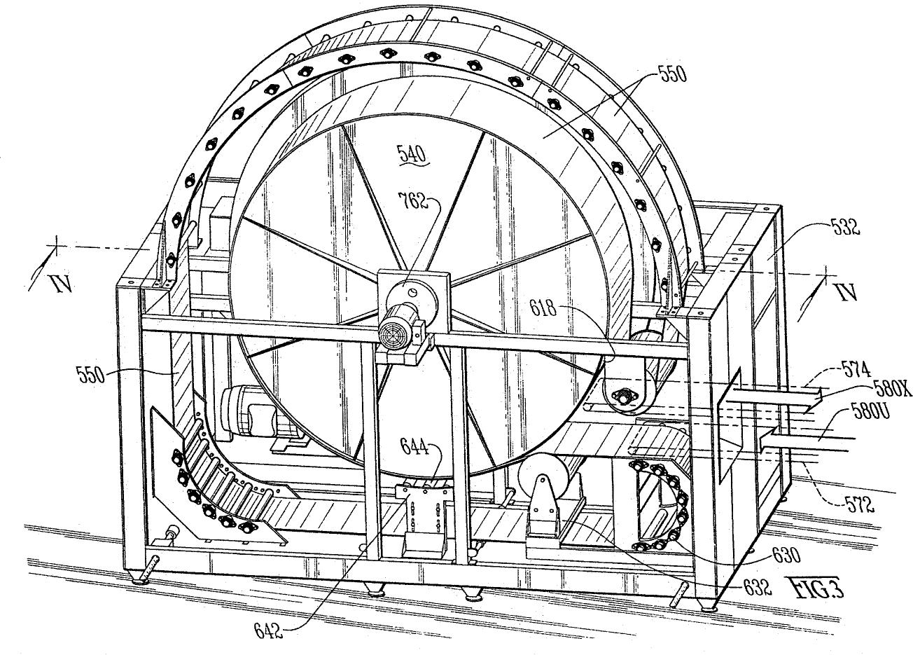

FIG. 2 shows the hard drum 540 as well as the endless belt 550 for wrapping around the drum 540 fully in isolation of the housing sections 522 and 524, and also shown about nearly in isolation from all the supporting sub-systems therefor.

The contact drum freezer system 500 in accordance with the invention would preferably be stationed to one side 562 of a linear automated and/or mechanized food process line 512. Thus this the infeed/outflow side 572, 574 of the contact drum freezer system 500 as shown in FIG. 1 is stationed to one side 562 of the food process line 512 (eg., relative to the relative upline 564 to downline 566 path of the food process line 512).

A system of direction-changing transfer conveyors 572 and 574 would have at least one direction-changing transfer conveyor 572 shifting un-frozen food 580U product off the linear transit path (564 to 566) of the food process line 512 (apart from the contact drum freezer system 500) onto the infeed run 552 of the endless belt 550 for the contact drum freezer system 500. At least one other direction-changing transfer conveyor 574 would shift the frozen food product 580X outflowing from the contact drum freezer system 500 back onto the linear transit path (564 to 566) of the food process line 512. Thus in some short lineal length of about four feet or so, food product 580 goes from being un-frozen to frozen by virtue of the side-stationed contact drum freezer system 500. Preceding, upline 564 stations or systems in the food process line 512 might comprise any of loading, forming, dry-coating, seasoning, battering, par-frying and so on. Succeeding, downline 566 stations or systems in the food process line 512 might comprise packaging and the like. The food process line 512 as a whole might stretch out over one hundred feet or more.

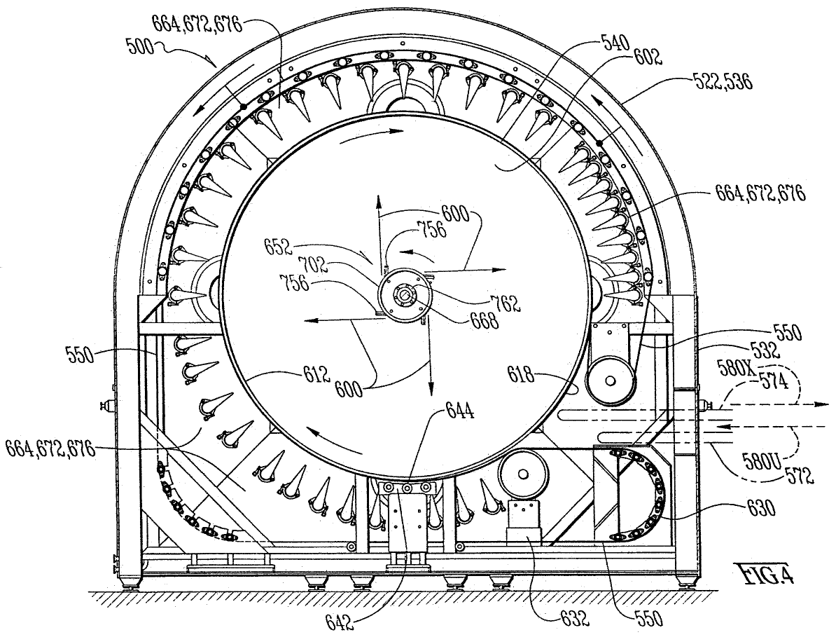

To return to FIG. 2, it shows the hard drum 540 as well as the endless belt 550 for wrapping around the drum 540 nearly in full isolation. To look ahead to FIGS. 3-5, a contact drum freezer system 500 in accordance with the invention for automated and/or mechanized food process lines 512 comprises such a machine 500 or component that includes without limitation the following major elements and/or support systems therefor:—
1. a hollow drum 540 and its support systems;
2. an endless belt 550 which preferably comprises a continuous web of stainless steel sheet whereby the outflow of food product 580X will not include texture markings of a textured belt;
3. an INSIDE treatment system 602 of the machine 500 (eg., coolant 600 distributed to the inside surface 612 of the hollow drum 540); and
4. an OUTSIDE treatment system 604 of the machine 500 (a series of curtains 614 of chilled air aimed on the outside surface of the belt 550).

Arguably, when an observer observes the rotation of the drum 540, that scene might remind the observer of an old-fashioned water wheel (for example and without limitation, an overshot water wheel) of an old-fashioned 1800's (nineteenth century) grist mill. The drum 540 is relatively large in diameter, relatively narrow in width, and turns slowly. However, the outer cylindrical surface 618 of this drum 540 comprises a continuously smooth hoop of stainless steel sheet (or of any other food grade approved material). An example diameter includes without limitation eight (8) feet, such choices on other diameters being a balance of choice to the scaling of the power consumption to factory ceiling height and so on. Example working widths include without limitation 14″, 24″, 40″ and 48″. Example rotation speeds include without limitation one rotation every two minutes (½ rpm).

The drum 540's outer cylindrical surface 618 (eg., hoop sidewall) provides the inside freezing contact surface for food product 580. The outer cylindrical surface 618 is chilled on the inside surface 612 by impinging coolant fluid 600 held at some selected setpoint (eg., minus forty degrees). The quantity (gpm), velocity (ft/min), drop size, and flow pulsation of the impinging coolant 600 are all variables in providing the outer cylindrical surface 618 with the capability of very high amounts of heat exchange (eg., energy extraction from the food product 580). As the coolant fluid 600 is thrown at the inside cylindrical surface 612, it is an object of the invention that the coolant fluid 600 actually hit the inside cylindrical surface 612, and this depends in part on the location of the impingement, and controlling impeding factors such as the diversion and removal of already landed fluid 600 and the prevention of thick layers of fluid 600. Such impeding factors could impede and dampen the ability of the outer cylindrical surface 616 to get all the way down to the setpoint temperature. These impeding factors are minimized by side flow diverters 622 around the inside of the drum 540 to guide a return flow of coolant fluid 600 to a drain ring 624 and away from the heat transfer surface (ie., the inner cylindrical surface 612).

FIG. 3 has the hoods 536 and 538 removed from view (as well as the near sidewall of the near cabinet 532, which houses the an INSIDE treatment system 602) to better show the drum 540 and endless belt 550 as well as to better show portions of the supporting sub-systems therefor.

Any or all of FIGS. 1-4 provide indications/illustration of food product paths, solid stainless steel belt 550, frozen food product 580X exit (or outflow), unfrozen food product 580U infeed, frozen food product 580X separation (and ultimate ejection) from both the drum 540 and belt 550, a belt tensioning system 630 and 632, a food product 580 pre-squeeze or compression system, and a cooperating food product 580 thickness control system.

FIG. 2 provides a view of the first roller 630 or set of rollers 630 that incoming food product 580 transits over, and over which the belt 550 would roll. This roller 630 and set of rollers 630 might be referred to as a ‘prep’ or ‘clearance’ roller(s) 630. This(these) prep roller(s) 630 is(are) preferably mounted on a ‘sled’ 632 that is biased to provide constant-force tension on the belt 550.

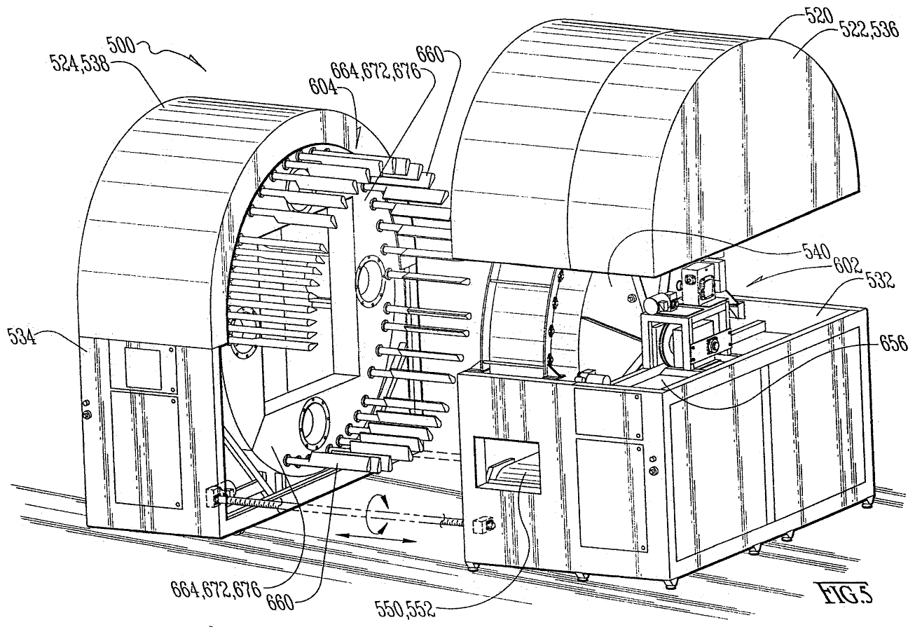

FIG. 4 also shows a series of three (3) ‘gauge’ rollers 642 (product pre-squeeze or compression system 644) which gird an arc at the bottom of the drum 540 and compress the food product 580 to the desired thickness (ie., in cooperation with the product thickness control system). Thus the desired objective is that the food product 580 preferably comprises a stream of food product pieces 580 (eg., hamburger patties) that are uniformly flat and share a uniform thickness.

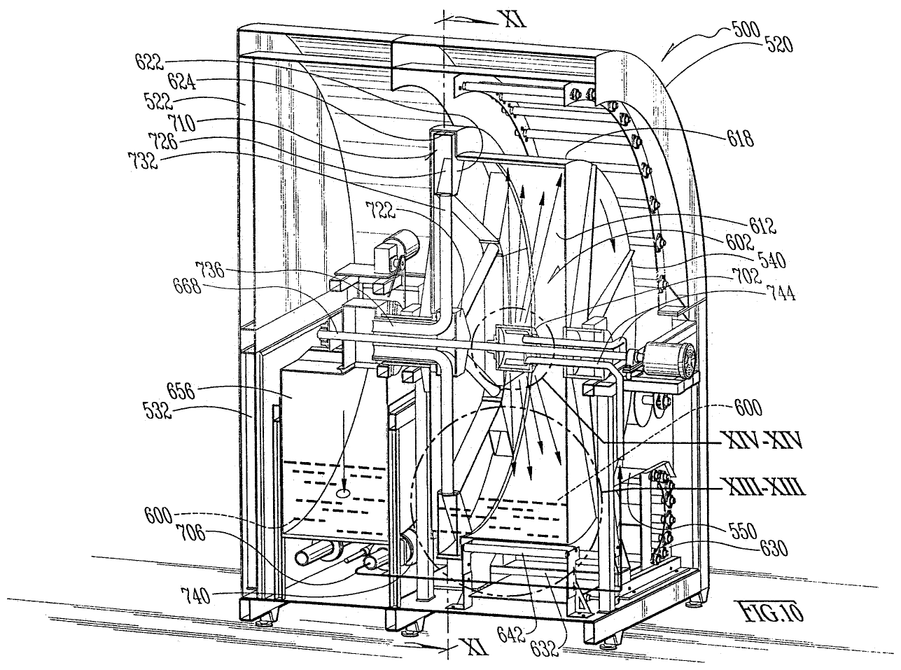

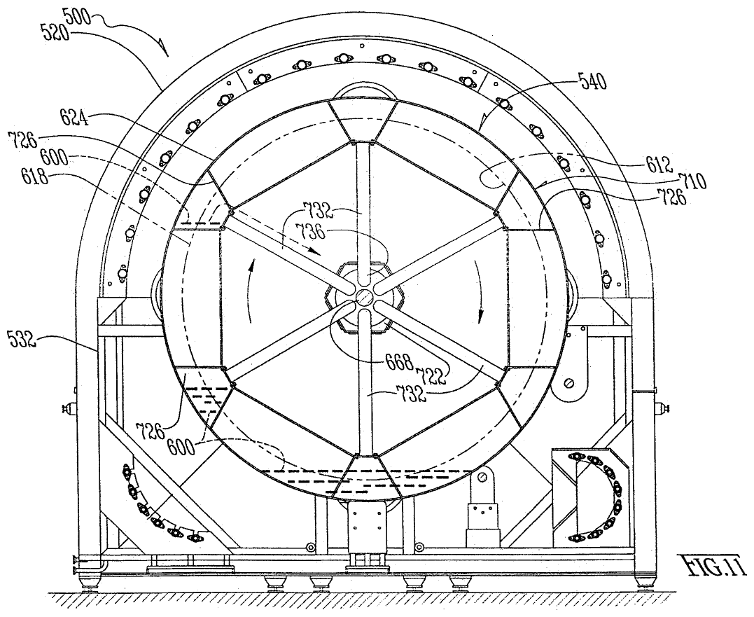

FIG. 4 also shows aspects of the coolant slinging system 652 within the interior of the drum 540, and a plenum configuration (eg., see below in connection with FIGS. 8 and 9, reference numerals 664, 672 and 676) that surrounds the drum 540 and belt 550 with well below-freezing chilled air. Again the solid belt 550 presses food product 580 such that there is good thermal contact that the food product 580 makes with both the outer cylindrical surface 618 of the drum 540 the inner cylindrical surface of the belt 550.

Fans 661-64 are employed to force the well below-freezing chilled air through narrow elongated slit-like nozzles 660 aimed at the outer cylindrical surface of the belt 550. That way, the food product 580 receives bilateral freezing service from the contact with the drum 540 on the inside surface of the food product 580 and the belt 550 on the outside surface of the food product 580.

Again, FIGS. 2-4 generally allow discernment of a pre-thickness roller 630 that first initially compresses food product 580 and then thickness gauge rollers 642 employed to reach a selected thickness for the food product 580.

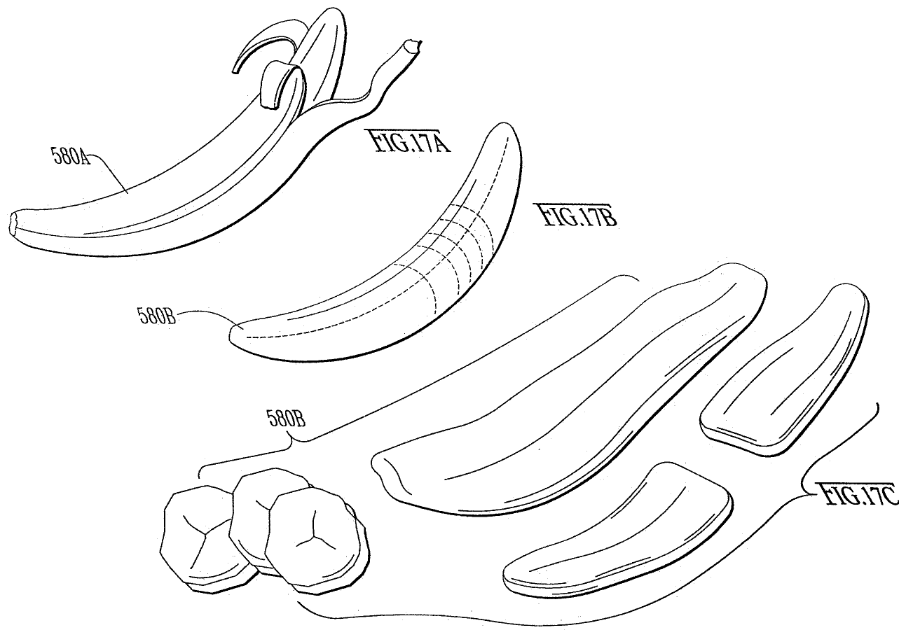

FIG. 4 shows basic aspects of the coolant slinger system 652 that will be described more particularly below in connection with FIG. 14, as well as basic aspects of food product 580 separation from the drum 540 and belt 550 as well as ultimate discharge.

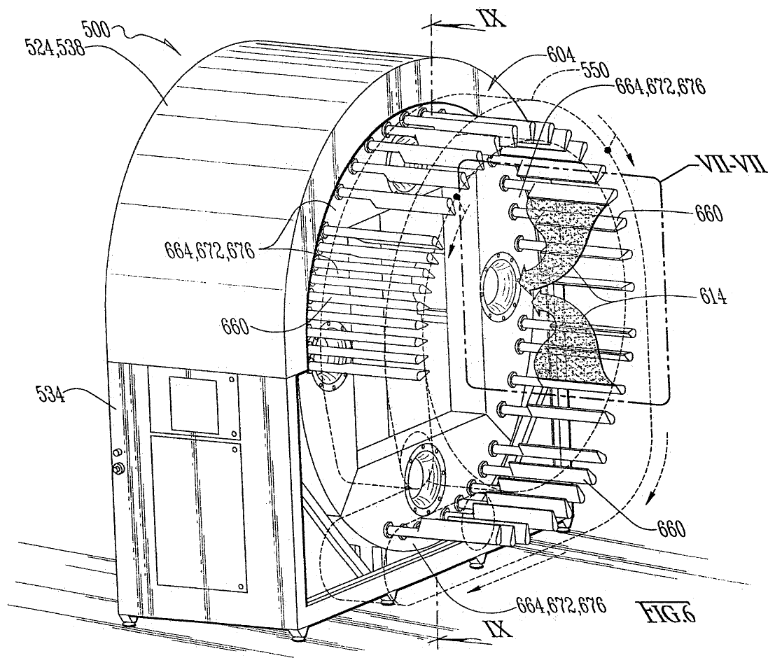

FIG. 5 shows the pair of housing sections 522 and 524 slid/moved laterally APART. The nearer section comprises the INSIDE treatment housing section 522 and its hood 536 is elevated OPENED. The further section comprises the OUTSIDE treatment housing section 524 and its hood 538 remains lowered CLOSED.

It is an aspect of the invention that the housing sections 522 and 524 are slidable/movable to a spread APART state as for cleaning (and maintenance and so on).

Again, in FIG. 5, the right half 522 of the machine 500 (housing section 522) comprises the drum 540 and the coolant reservoir 656 and is referred to as the INSIDE treatment system 602 of the machine 500. The left half 524 comprises an annular ring of air knives 660 (that produce the curtains 614 of chilled air) and is referred to as the OUTSIDE treatment system 604 of the machine 500.

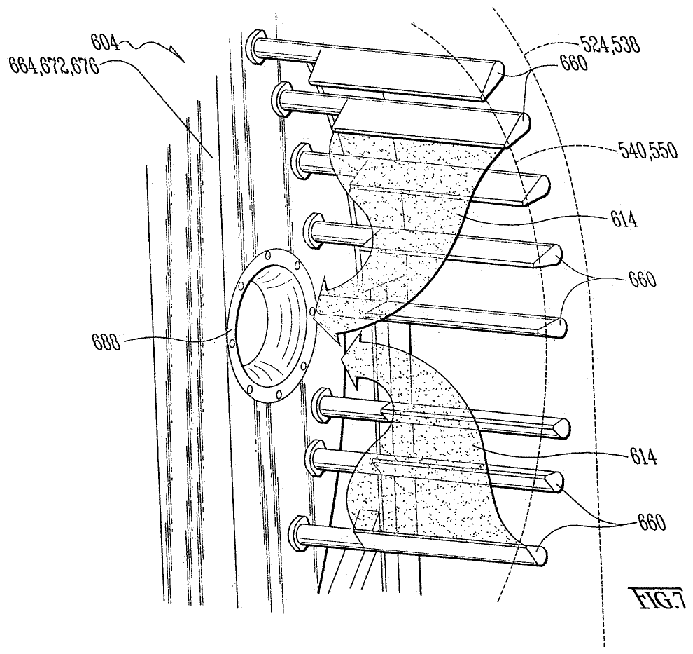

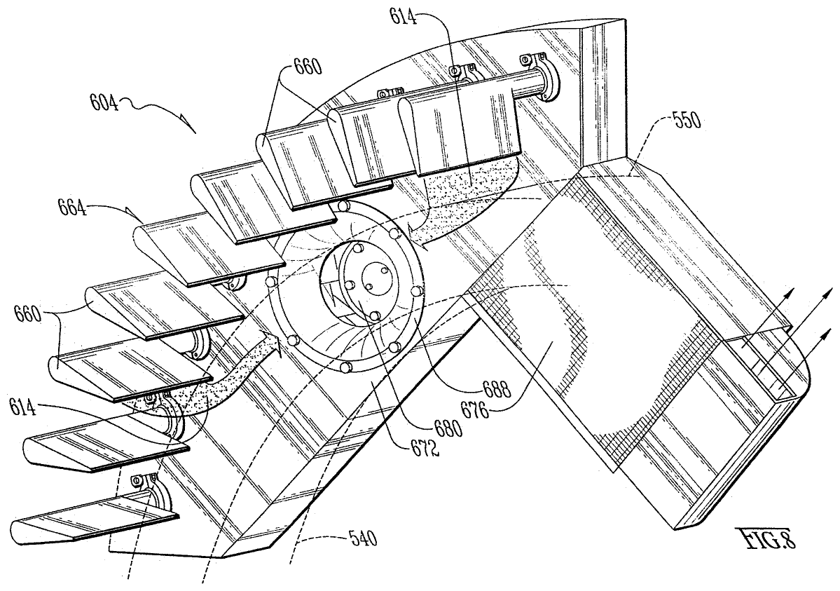

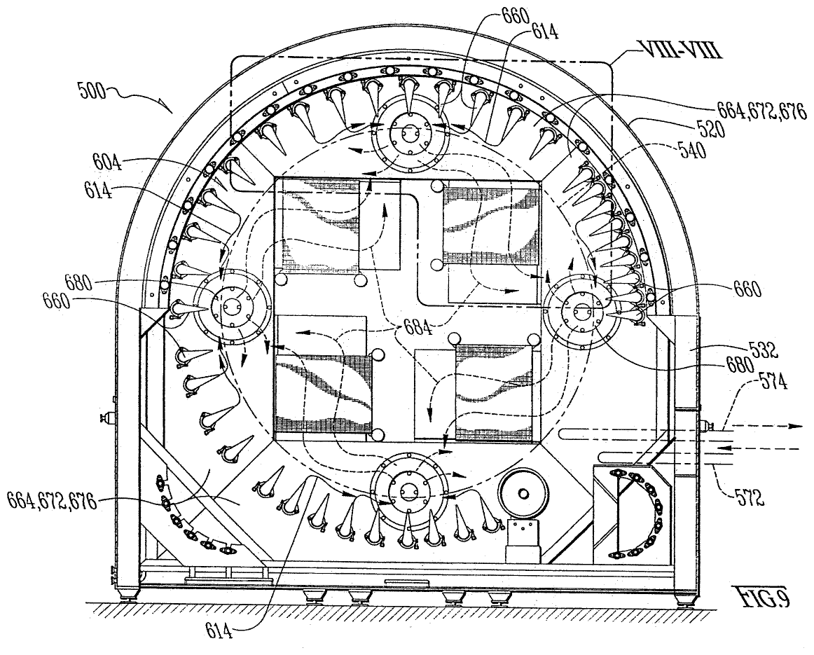

FIGS. 6 and 7 better show aspects of the OUTSIDE treatment system 604 for the machine 500. As mentioned above, the OUTSIDE treatment system 604 comprises an annular ring of air knives 660 blasting well-below freezing curtain 614 of chilled air directly at close range onto the outside of the belt 550.

FIG. 7 shows better on an enlarged scale of one (1) bank 664 of the four (4) banks 664 of air knives 660. Preferably each bank 664 comprises an equal number of air knives 660 to balance the pressurization thereamong (and presumably outflow therefrom). An example number of air knives 660 per bank 664 including without limitation nine (9) or so.

FIG. 8 is an enlarged-scale perspective view of detail VIII-VIII in FIG. 9. Alternatively, FIG. 8 is a radially-outboard perspective view of several of the air knives 660 from a vantage point close to the central turning axis 668 of the drum 540 (the drum 540 is not in view). FIG. 8 shows one of the four (4) identical banks 664 comprising an air plenum 672, an air cooler 676, a blower 680 and a plurality of air knives 664. Wherein the air loop 684 is a closed system and circulates serially from one bank 664 to the next and so on, progressively circulating in a loop around the four (4) banks 664 and impinging on the outside of the belt 550. As mentioned previously, the belt 550 preferably comprises a continuous web of solid stainless steel sheet. Not only will the outflow of food product 580 will not include texture markings of a textured belt, but the energy extraction of above-freezing temperature out of the food product 580 will be increased.

Again, FIG. 8 shows aspects of the air plenum configuration 664, 672 and 676, the roto-freeze technology 500, the air nozzles 660, the chilled air flow path 684 to next plenum, the air plenum 672, the air chiller 676 and a fan 680 inlet 688.

FIG. 9 is a section view taken along line IX-IX in FIG. 6. Alternatively FIG. 9 is a left side elevational view of the OUTSIDE treatment system 604 of the machine 500 in the foreground and portions of the drum 540 in the background indicated by dash line. Here, the four (4) separate combination air chillers 676 with air plenums 672 of the OUTSIDE treatment system 604 of the machine 500 are removed from view.

Thus, FIG. 9 shows aspects of the plenum configuration 664, 672 and 676, the drum/belt side showing air loops 684, a fan 680 inlet 688 (typical), air loop paths 684 both for nozzles 660 and chiller 676 (typical), and a typical complete air loop 684, wherein:
plenum 672 of bank 664 one to air nozzles 660 of bank 664 one,
to belt 550,
to fan inlet 688 of bank 664 two, and
Chiller 676 of bank 664 two from Plenum 672 of bank 664 two to next fan inlet 688 of bank 664 three, and so on in a loop:
   Chiller 676 of bank 664 one chilling exhaust of bank 664 four,
   Chiller 676 of bank 664 two chilling exhaust of bank 664 one,
   Chiller 676 of bank 664 three chilling exhaust of bank 664 two,
   Chiller 676 of bank 664 four chilling exhaust of bank 664 three, and then return to chiller of bank 664 one.

Regardless if redundant with the foregoing, FIG. 9 shows aspects of the plenum configuration for applicant's roto-freeze technology 500, access doors, plenums 672 numbers one through four, air path 684, and air chillers 676 numbers one through four.

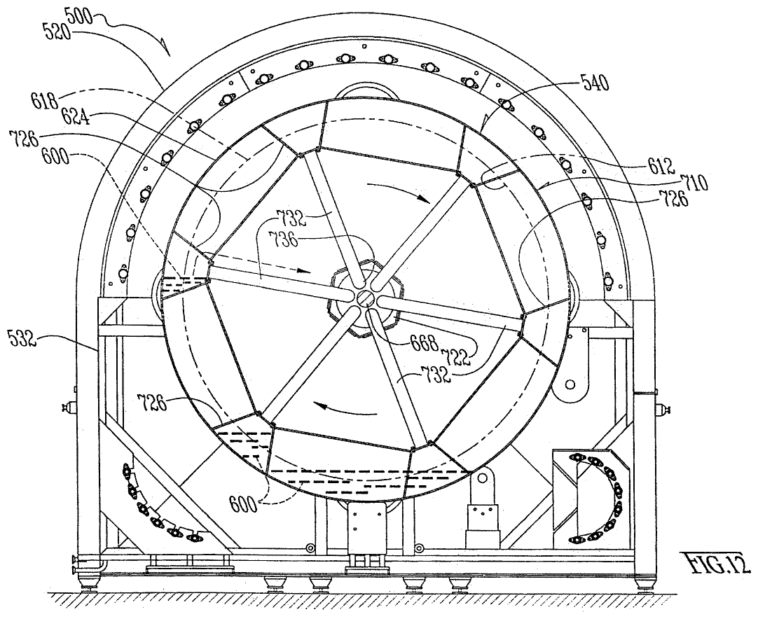

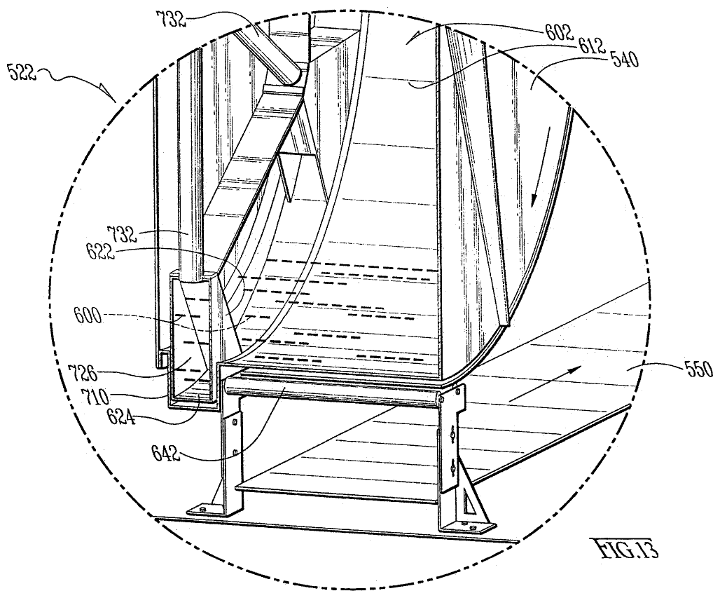

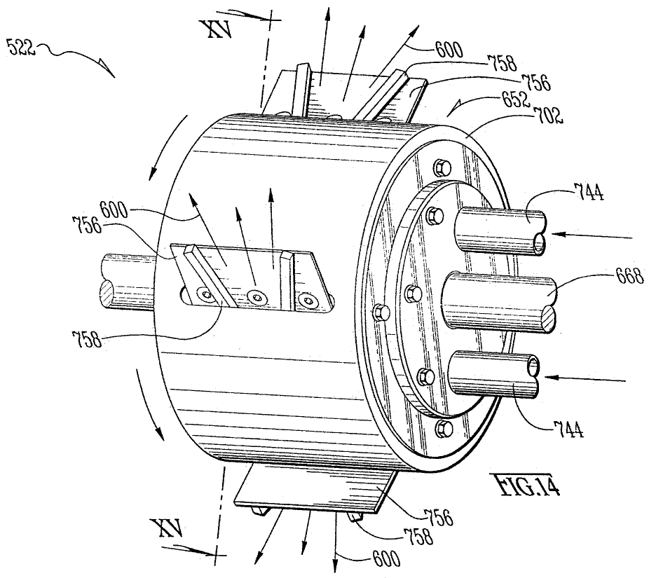

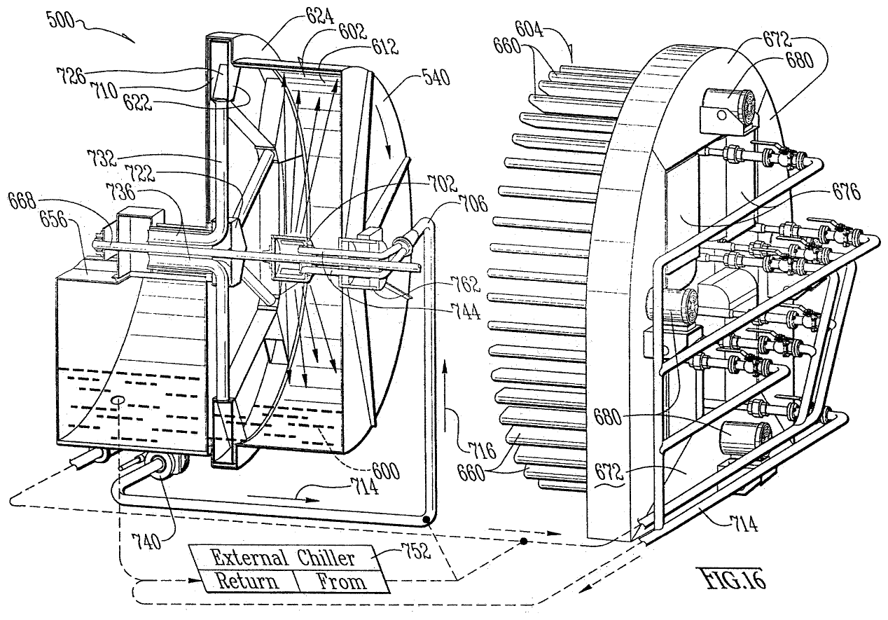

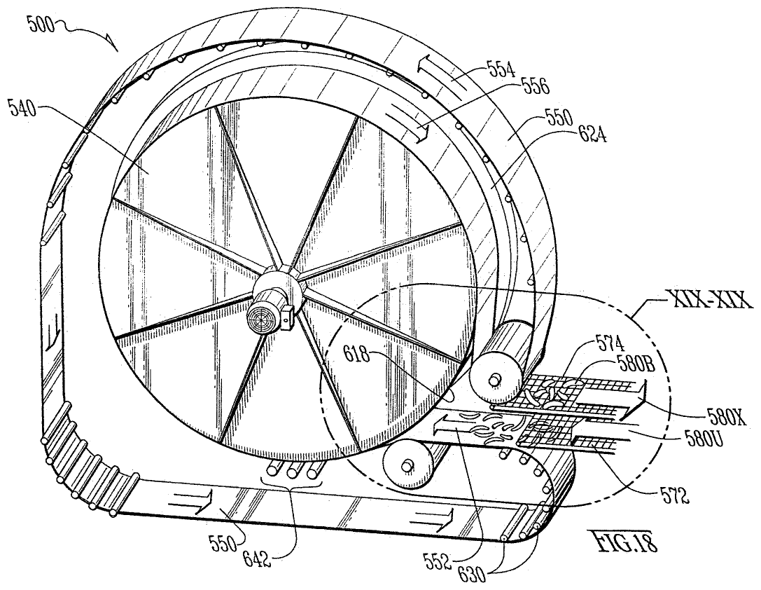

FIG. 10 is a section view taken along line X-X in FIG. 1, showing the internal coolant slinger 702 as well as the coolant flow paths 706 for this much of the machine 500 (eg., the INSIDE treatment system 602 of the machine 500). FIG. 10 as well as FIGS. 11-15 show better the return of the coolant 600 by the water-wheel provision(s) 710 of the drum 540.

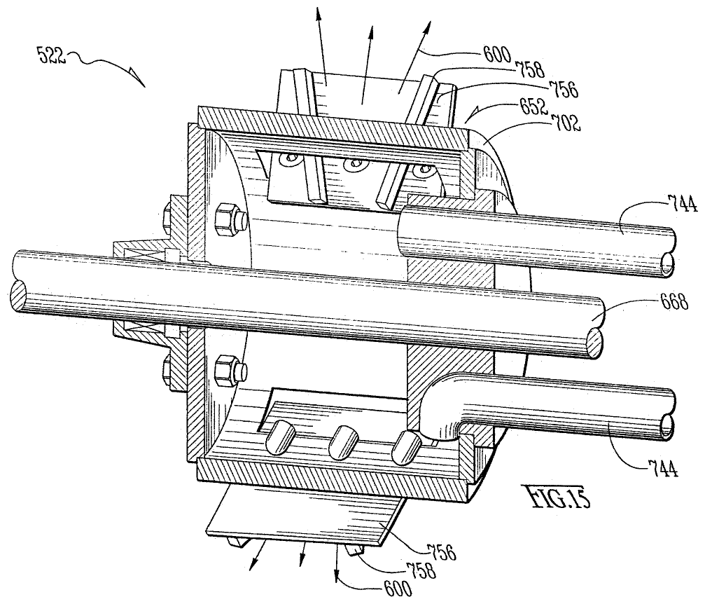

Note that FIG. 12 is a section view comparable to FIG. 11 except wherein the drum 540 has rotated forty-five degrees (45°) clockwise.

FIGS. 10-15 show aspects of the liquid loop 714 servicing the drum 540, applicant's roto-freeze technology 500, the drum 540, the slinger 702, the coolant fluid 600 inflow 716 into drum slinger 702 for distribution inside drum 540, the water wheel hub 722, the water wheel scoop/bucket 726, the liquid drainage 732 from scoop 726, the return 736 to the storage tank 656, the drain ring 624, and the pump 740 to slinger 702.

Regardless if redundant with the foregoing, FIGS. 10-15 show the coolant liquid path 706 for applicant's roto freeze technology 500, including:
1. Storage tank 656,
2. Piping 744 to slinger 702,
3. Slinger 702,
4. Impact inside drum 540,
5. Drainage-evacuation water wheel 722 and 726, and
6. Flow 736 back to tank 656.

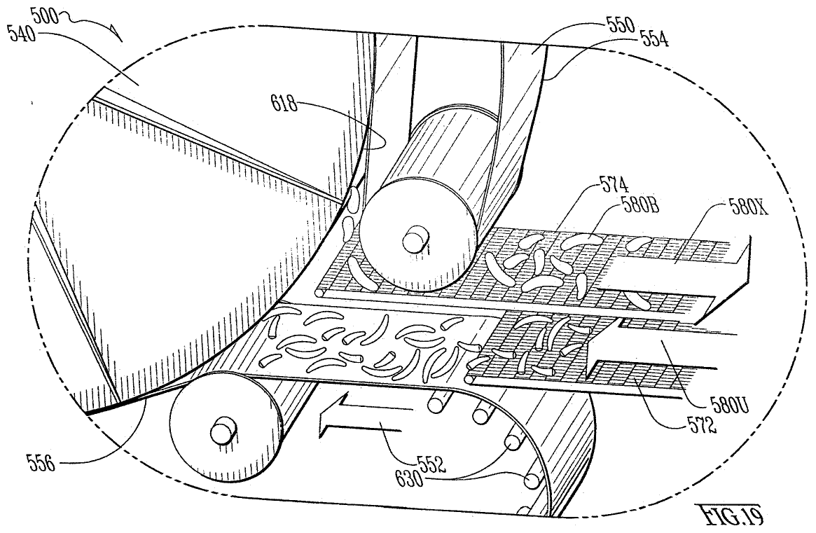

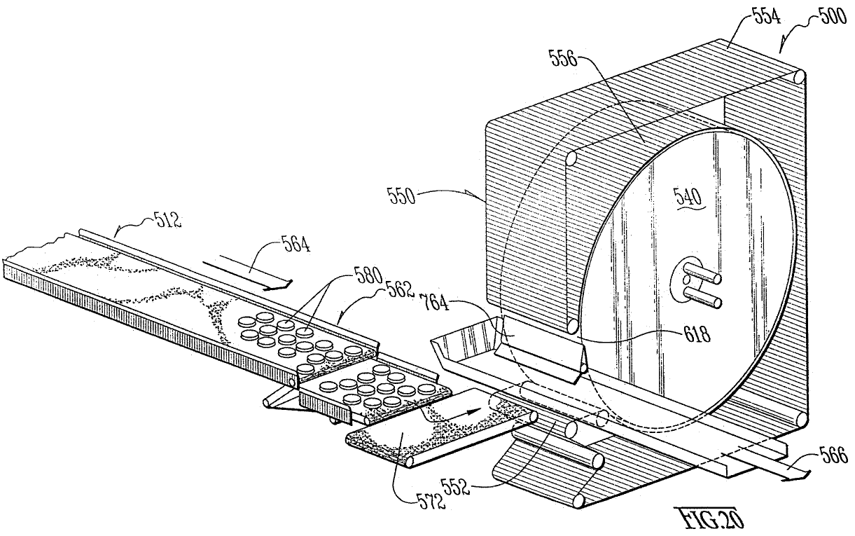

FIG. 16 is a perspective view comparable to FIG. 5 except not only with the housing sections 522 and 524 removed from view but also from a vantage point about one-hundred and eighty degrees (180°) counterclockwise (on the opposite side of the machine 500 from FIG. 5) to show better how there is a service of an external chiller 752 providing chilled coolant 600 to the D'Limonene loops (eg., 706) inside the machine 500 and serving both the INSIDE treatment system 602 (with which the emphasis is on the drum 540) as well as the OUTSIDE treatment system 604 (with which the emphasis is on the air-knives 660 directing well-below freezing temperature air onto the outside of the solid stainless endless wrapping belt 550).

FIG. 16 shows better that when the respective housing sections 522 and 524 are spread APART, the OUTSIDE treatment system 604 neatly separates from the INSIDE treatment system 602. Wherein, the belt 550 travels with the INSIDE treatment system 602, but one of the main objects of the OUTSIDE treatment system 604 is to chill the belt 550 to down below well-below freezing temperatures by means of a nearly continuous annularly-inward close range blast/curtain 614 of such cold air. Hence the annular ring of the air knife nozzles 660 are separate and neatly spaced apart from the outer cylindrical surface of the belt 550.

FIG. 16 shows aspects of not only the D'Limonene liquid coolant loop 706 for not only the OUTSIDE treatment system 604 but also the INSIDE treatment system 602, including the external chiller 752, applicant's roto-freeze technology 500, the coolant fluid storage tank 656, the flow back to storage tank 656, one or more air chillers 676, and the coolant fluid 600 into air chiller 676.

As an aside, the external chiller 752 might be a heat exchanger in which the external working fluid is ammonia. The ammonia lines and heat exchanger 752 are not wanted within indoor premises. Hence the external chiller 752 and the ammonia-flowing refrigeration equipment and lines are all preferably located remotely away and outdoors. The indoor coolant 600 is preferably limited to the safer-to-handle D'Limonene.

The following comprises a summary of operation given the foregoing matters above. Coolant fluid 600 flows in/out of the drum 540 by a centrifugal pump 740 that sends the fluid 600 over to the slinger 702 (by gpm or quantity) which delivers fluid 600 slung about three-hundred and sixty degrees (360°) inside the drum 540. Piping 744 brings the flow 600 into the inside of the slinger 702 and it is carried out by centrifugal force onto multiple blades 756 fitted with fanning fins 758 to spread the flow 600 to the width of the drum 540. The number of blades 756 also, along with the spinning speed of the slinger 702, creates the pulsation of the flow 600 onto the inside surface 612 of the drum 540. The tip speed of the blades 756 determines the velocity of the flow 600 into the inside surface 612 of the drum 540.

Containment of the coolant fluid 600. Fluid 600 is transported from the tank 656 to the drum 540 by piping 744 through both inlet and outlet spindles 762 of the drum 540. These spindles 762 also serve for the rotation of the drum 540 on bearings.

Drum Skin Metal. The heat transfer surface of the drum 540 is typically thin wall stainless steel (16 ga. or 0.0625″). Copper can also can be used (16 ga.). The thermoconductivity of copper is twenty-five times (25×) higher than stainless steel. Copper also has anti-microbial properties that could be advantageous.

Distribution of fluid (coolant 600) to the drum skin (eg., cylindrical inner wall 612). This preferably comprises a paddle slinger 702. The current slinger 704 has four (4) paddles (blades) 756 fitted with spreading fins 758 which fan the flow 600 out to the width of the drum 540. The paddles 756 also provide for separation of flow (pulsation), which creates a “pounding” of the fluid 600 onto the inside surface 612 of the drum 540. It also gives the fluid 600 time to flow away from the surface 612 before the next wave comes in, thus improving the “in and out” flow of fluid 600 on the surface 612.

There is alternatively a drum slinger (not shown). The preference of characteristics with a drum slinger vary with hole densities and sizes. Thickness of the wall thickness also provides for straightening of the flow from each hole, which improves fluid coverage into the surface, and overall heat transfer. The variance in nozzle (hole) definition (thickness) is from the thinnest at 16 ga. (0.0625″) up to one inch (1″) thick plastic (PVC). The thicker nozzle gives better exit stream definition (again, the foregoing are not shown).

Spray Nozzles could also be used (not shown). Typical water spray nozzles were arranged in a header (up to 10 across at spacing of 1.5″ apart) feeding a drum width of sixteen inches (16″). The multiple headers were positioned twelve inches (12″) apart (again, the foregoing are not shown).

With a fluid fill of coolant 600 in the drum 540, no distribution method need be utilized. Static storage of the coolant fluid 600 inside the drum 540 provides contact with the inside surface 612 keeping it at the temperature of the coolant fluid 600. Note this can be “still” fluid 600, or agitated or moving using either paddles or internal nozzles (these latter kinds of paddles and nozzles are not shown).

The evacuation and recirculation of the fluid 600 can be achieved by alternative means. The outer sidewall of the drum 540 is divided into eight sections (see, eg., FIG. 2, 3 or 18), but the interior of the drum 540 is divided into six sections (see, eg., FIGS. 11 and 12) each draining by pipes 732 from discrete adjacent tanks (eg., six annular sections of drain ring 624 as divided between scoops 726), as the drum 540 rotates, thus clearing the drum 540 of added fluid 600. If the treatment time is X seconds, but it takes more gallons than the drainage capacity of the tanks, fluid 600 can build up inside the drum 540.

In other words, there would be a drain ring 624 with a water wheel 710. If there is a continuous drain ring 624 around the drum 540 (to the side), and the fluid 600 is allowed to enter this drain ring 624, then a water wheel 710 containing scoops 726 to remove the fluid 600 can keep the drain ring 624 clear of accumulated fluid 600. This will allow the drum 540 to turn at very slow speeds, but the water wheel 710 running high enough speeds to keep all fluid 600 removed from the drain ring 624.

The water wheel 710 is a rotating array of scoops 726 or cups which fill up and drain fluid 600 out of the area. The speed is set according to the evacuation requirements of the fluid 600.

A pump pulls the fluid 600 out of the drum 540.

The preferred coolant fluid 600 includes without limitation D'Limonene. It is cooled by external refrigerants (eg., ammonia in outdoor heat exchanger 752) which have even lower working temperatures (eg., ammonia).

The OUTSIDE treatment system 604 of the machine 500 refers to the cooling of air for the impingement on the outside of the belt 550. The air should be cooled down to a setpoint of about −40° F. (−40° C.) or so. There would be air-handling plenums 672 and coolers 676. The coolers 676 preferably have a zig-zag flow of panels. These are-mounted outside the plenum 672 and are pressured from air from the plenum 672 and returning back into the inlet 688 of the blower 680.

Food product 580 handling is generally handled the following way. Unfrozen food product 580U is brought into the machine 500 on a wrapping belt 550. This mates with the drum 540 to form both inside and outside surfaces. This, being a solid metal belt 550, is non-porous (impervious) and will not allow any moisture migration from the surface of the food product 580, thus providing no escape point for yield loss. This also provides a smooth surface on both surfaces of the food product 580. A gauging (set of) roller(s) 642 puts pressure on the thickness of the food product 580 as it comes in contact with the food product 580. The belt tension system 630 and 632 maintains that thickness, thus allowing, when freezing, production of a thinner food product 580, which has strong advantages for food service needs and process (freeze or cook) time, both in control and reduction. The consistency of the thickness also allows for more predictable preparation times, which has great advantages to their operation.

The food product 580 freezes or is chilled by both contact with the drum 540's outer cylindrical surface 618 and the belt 550's inner cylindrical surface of the inner food-product compressing run 556. By holding the food product 580 between two solid surfaces (ie., the belt 550 and drum skin 618), pressure can be increased (increasing heat transfer) and processing thinner shapes can reduce the heat transfer time through the food product 580, while also improving the consistency of the temperature.

This machine 500 could be serviced with a thermal fluid other than a coolant fluid 600, and thus, instead of being a contact drum freezer system, the machine 500 would become a contact drum cooker system. Although this departs from the main design focus of freeze service.

But freezing has been the inspiration of the developments to date. The direct contact with a high heat transfer surface reduces the ice crystal size and growth, thus producing a superior food product 580. The smooth surface is an advantage. An impervious surface is believed to maximize processing yield and maintain food product 580 quality.

The machine 500 could be devised for thawing. This would be similar as freezing, threshold temperatures can be much more accurate thus maintaining food product 580 quality and maximizing process throughput, while avoiding “over cooked” extremities.

To re-devise for cooking, cooking can be maximized with highly accurate surface temperatures maintained. Moisture migration away from the surface is eliminated because of the solid surface.

Branding could be achieved too (this is not shown). It would be a much improved process due to higher controlled temperatures and conduction heat transfer. Heating grids can be placed just under the surface for direct heat transfer into regions of the food product 580, for example, pressing with a solid belt. The dual solid surfaces maximizes heat transfer and minimizes moisture and fluid loss, and produce an appealing profile, and which can be used to shape the food product 580 where otherwise not possible. This also could allow “cooking in gravy,” or also allow pouch processing, where food product 580 is pre-packaged and then processed (cook in the bag) for enhanced safety processing. This could change the packaging of food items from being in a can to in pouches (none of the foregoing is shown). There is also the ability for pressing with a mesh belt (not shown) and holding strips (breaded product, and which is non geometrical). This would allow the top treatment-air impingement, smoking, infrared, or other to surround the breaded product 580 without flattening it. And then there is also pressing for preshaping flatness and other shapes. This could allow for a “formed” product process, either cooking or freezing, for shaping during processing (once again, none of the foregoing are shown).

To return the OUTSIDE treatment system 604 of the machine 500, this is essentially an air impingement system (hot or cold), or steam impingement, or infrared, or smoke onto a solid belt 550 or onto the food product through a mesh belt (not shown). That way, there could be direct smoke impingement, directly onto the food product through the open interstices of the belt (again, the foregoing are not shown).

The overall configuration can be summarized briefly as follows. There are supply plenums 672, air nozzles 660 like single slot nozzles 660, eg., air knives 660 that have a single slot and produce a curtain 614 of air). There could be cross flow nozzles, developed in housing, causing a cross flow of air at exit for more chaotic air exchange with the surface and higher heat transfer (not shown). There could also be bell nozzles (hybrids), which convert a straight nozzle to more chaotic flow for better heat transfer (not shown). There could also be tube nozzles, which are tubes for delivery of an air column to the surface (not shown).

In contrast to direct impingement, there could also be indirect impingement. This would involve a solid belt 550 with impingement nozzles directed at the belt 550 and using the belt 550 as the heat transfer surface. There might be a belt with heated rollers that transfer heat into the belt instead of nozzles. There might be thermal mass blocks with or without a belt, but preferably with a belt, where the blocks contain enough mass to contain the heat for transfer to the belt and then to the food product. Or that the blocks might have a flat surface and act directly on the food product with no belt (none of the foregoing are shown).

The housing 520 for the machine 500 comprises a pair of cabinets 532 and 534 and a pair of hoods 536 and 538. The hoods 536 and 538 lift up (perhaps off) for cleaning. The cabinets 532 and 534 spread APART somewhat like a clam shell, again for access to the internal parts, maintenance, cleaning and so on.

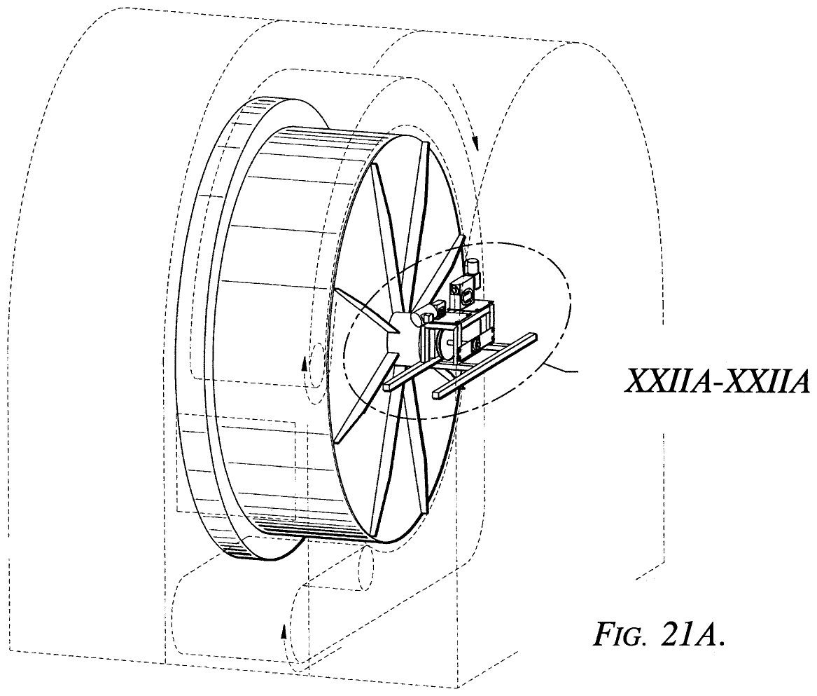

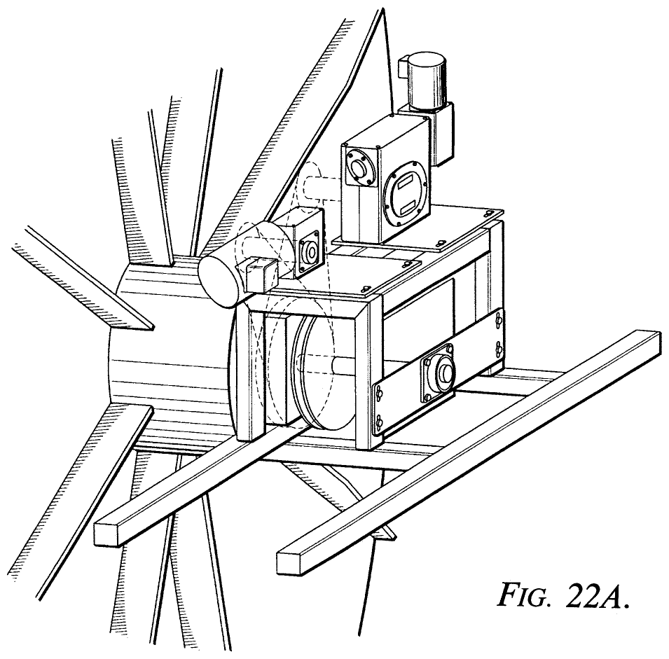

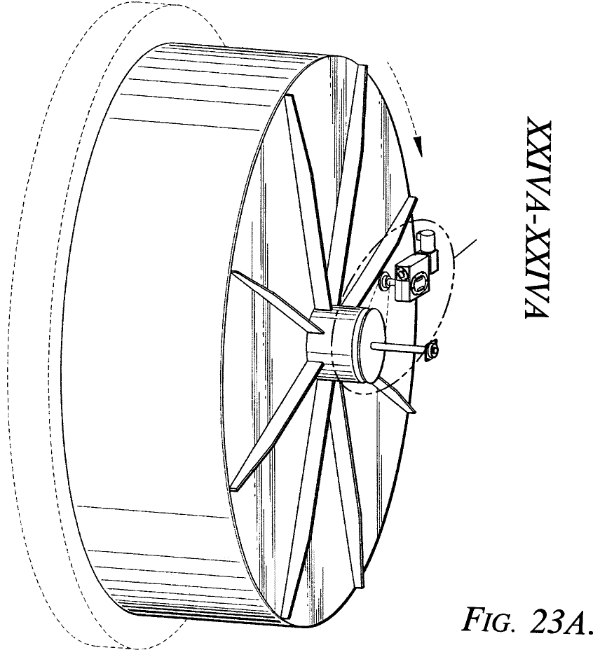

FIGS. 17A-17C comprise a set of perspective views of an exemplary food product 580A-B for freezing by the contact drum freezer system 500 in accordance with the invention, wherein:

FIG. 17A is a perspective view of a fresh in-the-peel banana 580A, with the peel being partly opened at the stem end;

FIG. 17B is a perspective view of a fresh, peeled banana 580B with potential slice lines indicated in dashed lines providing suggestions, if it were desirable to reduce the whole banana 580B down into pieces thereof, where such slices can be made; and

FIG. 17C is a shows the exemplary food product 580B being fed into the machine 500 for freezing by the contact drum freezer system 500 in accordance with the invention, which food product 580B might comprise any of:
a whole peeled banana,
halves of a peeled banana, or
sliced chips of a peeled banana.

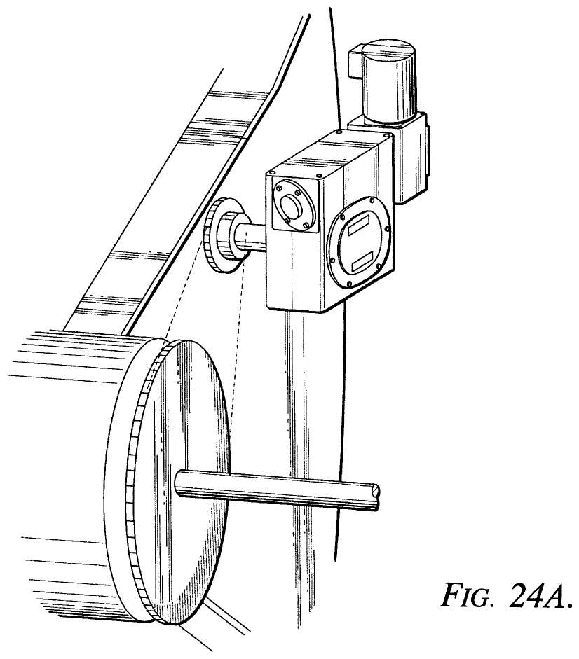

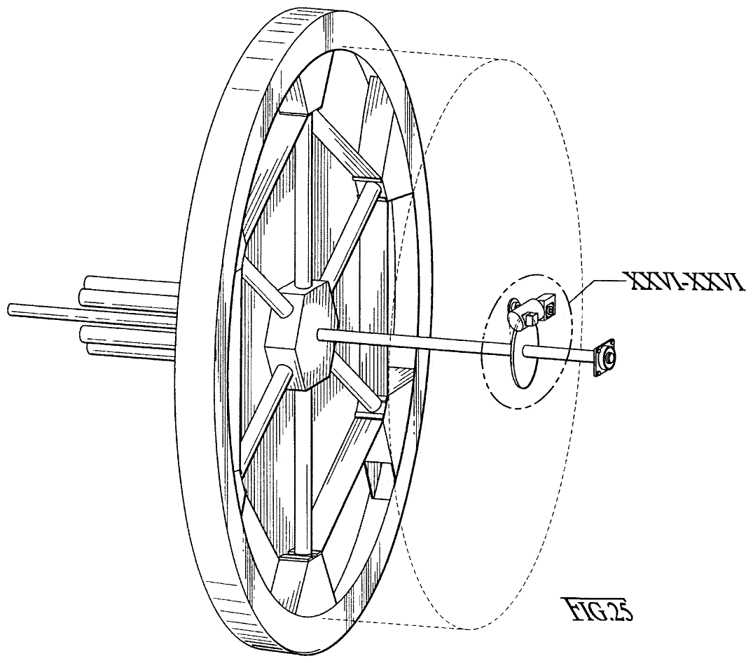

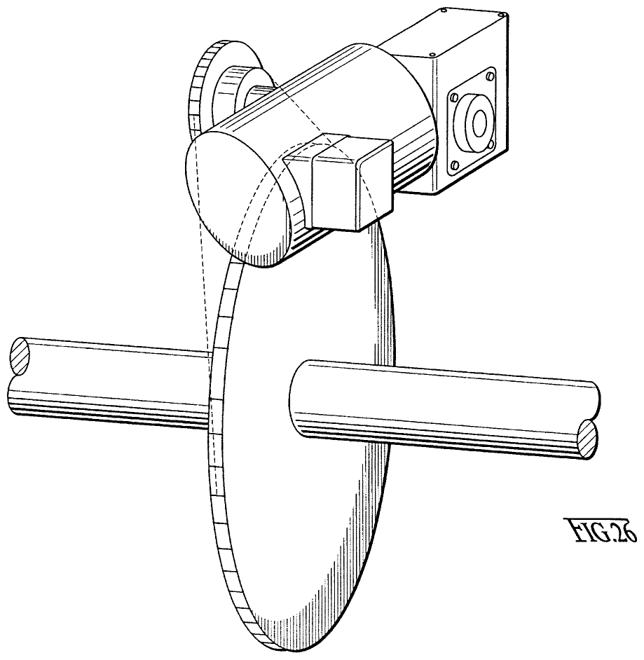

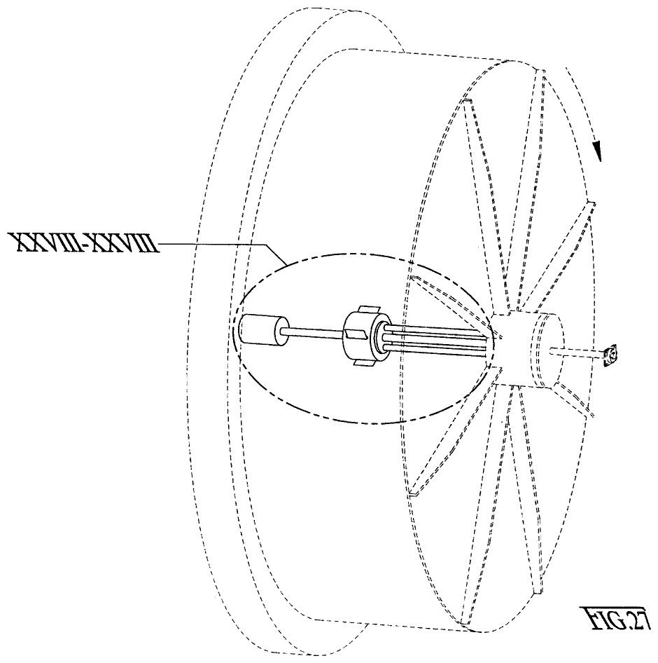

FIGS. 18 through 20 show the infeed and outflow of whole peeled bananas 580B through the contact drum freezer system 500 in accordance with the invention. The contact drum-freezer system 500 comprises a revolving drum 540 and a counterpart, endless product wrap belt 550 which has an outer return run 554 and an inner product-compressing run 556. This inner product-compressing run 556 provides the inner cylindrical surface portion of the belt 550 that provides the direct contact with the food product 580B on the outside. The outer surface 618 of the drum skin provides the direct contact with the food product 580B on the inside. The revolving drum 540's outer surface 618 and belt 550 travel at the same speed.

Fresh, whole peeled bananas 580B are fed into an infeed opening in the machine 500 on an infeed conveyor 572. The fresh, whole peeled bananas 580B are admitted for a ride comprising one circuit on the revolving drum 540's outer surface 618. At the termination of such a ride, the food product 580B (ie., banana here) is:—
laterally compressed,
frozen, and
ultimately discharged out of the machine 500.

The contact drum-freezer system 500 comprises biased belt-tensioning devices 630 and 632 for the product wrap belt 550 such that bananas 580B riding a circuit between the drum 540's outer surface 618 and the product wrap belt 550's product compressing run 556 are not only conveyed thereby, but concurrently laterally compressed thereby.

The contact drum freezer system 500 also comprises a source of refrigeration 752 and 600 for bringing the temperature of the drum 540's outer surface 618 to well-below freezing (eg., −40°). Thus bananas 580B riding a circuit between the drum 540's outer surface 618 and the product wrap belt 550's product-compressing run 556 are frozen by contact with the drum 540's outer surface 618's well-below freezing temperature and the product-compressing run 556's inner surface's well-below freezing temperature.

The product wrap belt 550 is held under a moderate tension, thus applying moderate pressure to the food product 580B and thereby moderately forcing the food product 580B between the freezing drum 540 and the freezing belt 550. Such pressure increases the heat transfer rate of the freezing. The application of pressure on the food product 580B between the drum 540 and belt 550 is achieved not only by the biased-tensioning devices 630 and 632 for the product wrap belt 550 but also by assistance from compression rollers (eg., 642) or compression belts (not shown) mounted along the arc or arc segments of the product wrap belt 550. As food product 580B rides a circuit on the drum 540's outer surface 618 and freezes, the food product 580B (or 580X) approaches one or more scraper blades 764, which scrape or separate the frozen product 580B (or 580X) off and away from the drum 540 and belt 550.

Experience finds that a minuscule interface or layer of ice crystals forms between the drum 540 and inside surface of the food product 580B (or 580X), as well as, between the belt 550 and outside surface of the food product 580B (or 580X). Since the freezing rates at the product-drum and/or product-belt interface are very fast, the ice crystals are very small. This allows food product 580B (or 580X) to be easily scraped off the respective drum 540 and belt 550 surfaces. By these means, both the food product 580B's (or 580X's) inner side (ie., the drum-contact side) and outer side (ie., the belt-contact side) are very smooth. Preferably the overall shape of individual pieces of food product 580B (or 580X) is very flat, which serves well for closely-spaced packing in cases or cartons. Likewise, the food product 580B's (or 580X's) outer side (eg., the belt-contact side) is flat as well due to the product wrap belt 550 being a continuous film. A preferred material for the product wrap belt 550 is solid stainless steel sheet. “Solid” here means, absence of open interstices such as perforations or chain link and otherwise.

Once the food product 580B (or 580X) reaches the scraper blades 764 and is pried away from the surfaces of the drum 540 and belt 550, the food product 580B (or 580X) falls onto an outflow conveyor 574. The outflow conveyor 574 transfers the frozen product 580B (or 580X) onwards, to downline processes that are not shown, perhaps by means of intermediary transfer conveyors that change the path of the outflowing food product 580B (or 580X) to right angles of the outflow conveyor 574. Such downline processes could include without limitation packaging or scaling areas where food product 580B (or 580X) is apportioned, bagged, sealed, boxed and stacked on pallets for shipping or the like.

It is an advantage of the invention that food product 580 can be frozen over a brief time span during which a flat shape is maintained, with both broad sides of the food product 580 being maintained very smooth. The food product 580 is subjected to freezing process simultaneously with being mechanically compressed in a progressively thinning gap between converging broad flat surfaces of the drum 540 and belt 550, and not by vacuum compression, screw compacted, extrusion or other.

These and other aspects and objects are provided according to the invention as non-exclusively characterized without limitation as follows.

One. A contact drum freezer system 500 comprising:
a contact drum 540 freezer mounted to revolve about an axis 668 generally parallel to a main lane of transit 512;
an endless product wrap belt 550 having an intake shelf 552, an inner product-compressing run 556 encircling most of the drum 540 and an outer return run 554 looping back to the intake shelf 552; and
a cross feed conveyor 572 situated in the main lane of transit 512 having a return run and product-carrying run for transferring product 580 laterally out of the main lane of transit 512 and onto the intake shelf 552 of the product wrap belt 550;
wherein said contact drum freezer 500 comprises a hollow drum 540 and support systems therefor;
said contact drum freezer system 500 further comprises an INSIDE treatment system 602 for the hollow drum 540; and
said contact drum freezer system 500 further comprises an OUTSIDE treatment system 604 for the endless product wrap belt 550.

Two. The contact drum freezer system 500 of One, wherein:
the OUTSIDE treatment system 604 for the endless product wrap belt 550 comprises a series of curtains 614 of chilled air aimed on the outside surface of the endless product wrap belt 550.

Three. The contact drum freezer system 500 of Two, wherein:
the endless product wrap belt 550 preferably comprises a continuous web of stainless steel sheet whereby the belt 550 is food grade and a good thermal conductor, as well whereby the outflow of food product 580X will not include texture markings of a textured belt.

Four. The contact drum freezer system 500 of three, wherein:
the INSIDE treatment system 602 for the hollow drum 540 comprises a fluid coolant 600 distributed to the inside surface 612 of the hollow drum 540.

Five. The contact drum freezer system 500 of Four, wherein:
the coolant 600 comprises D'Limonene.

Six. The contact drum freezer system 500 of One, further comprising:
a housing 520 for the contact drum freezer system 500;
wherein the housing 520 comprises a cabinet 532, 534 and hood 536, 538;
wherein the hood 536 and/or 538 lifts off for cleaning; and
the cabinet 532, 534 comprises a first and second opposed clam shell-inspired structures 532 and 534 that spread apart from one another whereby providing access to internal parts and for maintenance and cleaning.

Seven. The contact drum freezer system 500 of Six, wherein:
the OUTSIDE treatment system 604 for the endless product wrap belt 550 is supported by the first clam shell-inspired structure 534, and travels with the first clam shell-inspired structure 534 when the first clam shell-inspired structure 534 is spread apart from the second clam shell-inspired structure 532.

Eight. The contact drum freezer system 500 of Seven, wherein:
the INSIDE treatment system 602 for the hollow drum 540 is supported by the second clam shell-inspired structure 532, and travels with the second clam shell-inspired structure 532 when the second clam shell-inspired structure 532 is spread apart from the first clam shell-inspired structure 534.

Nine. The contact drum freezer system 500 of Eight, wherein:
the OUTSIDE treatment system 604 for the endless product wrap belt 550 comprises a series of curtains 614 of chilled air aimed on the outside surface of the endless product wrap belt 550.

Ten. The contact drum freezer system 500 of Nine, wherein:
the endless product wrap belt 550 preferably comprises a continuous web of stainless steel sheet whereby the belt 550 is food grade and a good thermal conductor, as well whereby the outflow of food product 580X will not include texture markings of a textured belt.

Eleven. The contact drum freezer system 500 of Ten, wherein:
the INSIDE treatment system 602 for the hollow drum 540 comprises a fluid coolant 600 distributed to the inside surface 612 of the hollow drum 540.

Twelve. The contact drum freezer system 500 of Eleven, wherein:
the coolant 600 comprises D'Limonene.

### I

FIGS. 21-24 show the location of the various electric-powered drive motors which do the following work:
the electric-powered drive motor for the water wheel;
the electric-powered drive motor for the drum;
the electric-powered drive motor for the belt;
the electric-powered drive motor for the D'Limonene flow that loops through the air chillers; and
the electric-powered drive motor for D'Limonene flow that loops through the drum including being slung out by the slingers inside the drum.

FIG. 10 shows:
the various electric-powered drive motor for the slinger.

All the electric-powered drive motors are variable speed and are controllable by a control system programmed with an algorithm. Control parameters vary greatly with food product. For example, the dwell time (time from infeed to outflow) for frozen bananas might be five (5) minutes; for thick hamburger patties it might be forty (40) minutes.

To turn to the slinger, the scoops and drum, all are driven independently, and in order of turning speed:
the slinger is turned at the highest speed;
the scoops are turned at intermediate speed but turn in the same direction as the scoops; and
the drum is turned at the slowest speed and turns counter-rotationally relative to the slinger and scoops.

The belt is driven to correspond to the turning ratio of the drum so as not to shear the food product into a smear when pinched between the drum and belt.

The electric-drive motors for the respective D'Limonene loops are driven to provide sufficient flows as cooling service demands.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

1. A contact drum freezer system (500) comprising:
a hollow drum (540) mounted to revolve about an axis (668);
an endless product wrap belt (550) having an intake run (552), an inner food product-compressing run (556) encircling most of the drum (540) and an outer return run (554) looping back to the intake run (552); and
a feed apparatus (572) transferring unfrozen food product (580U) onto the intake run (552) of the product wrap belt (550);
wherein the drum (540) has an inside cylindrical surface (612) and an outer cylindrical surface (618);
the belt (550) has an infeed run (552), an inner food product-compressing run (556) and an outer return run (554) returning to the infeed run (552);
wherein the belt (550)'s inner food product-compressing run (556) forms an outer cylindrical surface and an inner cylindrical surface compressing food product (580) against the outer cylindrical surface (618) of the drum (540);
said contact drum freezer system (500) further comprises an INSIDE treatment system (602) for the hollow drum (540); and
said contact drum freezer system (500) further comprises an OUTSIDE treatment system (604) for the endless product wrap belt (550);
the OUTSIDE treatment system (604) comprises an annular ring of forced, chilled air exhausts (660) arranged and disposed relative to the outer cylindrical surface of the belt (550)'s inner food product-compressing run (556) so as to produce an annularly-inward close range blast (614) of such chilled air directly thereon.

2. The contact drum freezer system (500) of claim 1, wherein:
the endless product wrap belt (550) comprises a continuous web of stainless steel sheet.

3. The contact drum freezer system (500) of claim 1, further comprising:
a bifurcated housing (520) for the contact drum freezer system (500);
wherein the bifurcated housing comprises an INSIDE treatment housing section (522) and an OUTSIDE treatment housing section (524) which housing sections (522 and 524) can be separated APART, whereby for cleaning or maintenance, and returned back to CLOSED whereby for run operations;
the drum (540) and belt (550) are mounted within and slide or move between APART and CLOSED with the INSIDE treatment housing section (522); and
the OUTSIDE treatment system (604) is mounted within and slides or moves between APART and CLOSED with the OUTSIDE treatment housing section (524).

4. The contact drum freezer system (500) of claim 3, wherein:
when the OUTSIDE treatment housing section (524) is slid or moved from an APART disposition to a CLOSED disposition, the annular ring of forced chilled-air exhausts (660) insert between the belt (550)'s inner product-compressing run (556) and outer return run (554).

5. The contact drum freezer system (500) of claim 1, wherein:
the annular ring of forced chilled-air exhausts (660) comprises an annular ring of air knives (660), each comprising an elongated slit-like exhaust slot which individually produce a curtain (614) of forced chilled-air, and which cooperatively produce the annularly-inward close range blast (614) of such chilled air directly onto the outer cylindrical surface of the belt (550)'s inner food product-compressing run (556);
whereby the food product (580) receives bilateral freezing service from the contact with the drum (540) on the inside surface of the food product (580) and the belt (550) on the outside surface of the food product (580).

6. A contact drum freezer system (500) comprising:
a hollow drum (540) mounted to revolve about an axis (668);
an endless product wrap belt (550) having an intake run (552), an inner food product-compressing run (556) encircling most of the drum (540) and an outer return run (554) looping back to the intake run (552); and
a feed apparatus (572) transferring unfrozen food product (580U) onto the intake run (552) of the product wrap belt (550);
wherein the drum (540) has an inside cylindrical surface (612) and an outer cylindrical surface (618);
the belt (550) has an infeed run (552), an inner food product-compressing run (556) and an outer return run (554) returning to the infeed run (552);
wherein the belt (550)'s inner food product-compressing run (556) forms an outer cylindrical surface and an inner cylindrical surface compressing food product (580) against the outer cylindrical surface (618) of the drum (540);
said contact drum freezer system (500) further comprises an INSIDE treatment system (602) for the hollow drum (540);
said contact drum freezer system (500) further comprises an OUTSIDE treatment system (604) for the endless product wrap belt (550); and
said contact drum freezer system (500) further comprising:
a bifurcated housing (520) for the contact drum freezer system (500);
wherein the bifurcated housing comprises an INSIDE treatment housing section (522) and an OUTSIDE treatment housing section (524) which housing sections (522 and 524) can be separated APART, whereby for cleaning or maintenance, and returned back to CLOSED whereby for run operations;
the drum (540) and belt (550) are mounted within and slide or move between APART and CLOSED with the INSIDE treatment housing section (522); and
the OUTSIDE treatment system (604) is mounted within and slides or moves between APART and CLOSED with the OUTSIDE treatment housing section (524).

7. The contact drum freezer system (500) of claim 6, wherein:
the respective INSIDE and OUTSIDE treatment systems (602 and 604), mounted respectively within the INSIDE and OUTSIDE housing sections (522 and 524) exclusively, both comprise respectively independent coolant delivery systems (652 and 676).

8. The contact drum freezer system (500) of claim 7, wherein:
the INSIDE treatment housing section (522) comprises a cabinet (532) and hood (536) which are movable between OPENED, whereby for cleaning and maintenance to the INSIDE treatment system (602), and shut whereby for run operations; and
the OUTSIDE treatment housing section (524) comprises a cabinet (534) and hood (538) which are movable between OPENED, whereby for cleaning and maintenance to the OUTSIDE treatment system (604), and shut whereby for run operations; and

9. The contact drum freezer system (500) of claim 7, further comprising:
an external chiller (752) disposed at a location remote from the contact drum freezer system (500); and
wherein the independent coolant delivery systems (652 and 676) comprising portions of the INSIDE and OUTSIDE treatment systems (602 and 604) respectively, likewise mounted respectively within the INSIDE and OUTSIDE housing sections (522 and 524) exclusively, both comprise respectively independent coolant delivery systems (652 and 676); and
the external chiller (752) refrigerates coolant (600) and loops the coolant (600) to and from the independent coolant delivery systems (652 and 676) by independent coolant paths (706 and 676).

10. The contact drum freezer system (500) of claim 9, further comprising:
the external chiller (752) is disposed outdoors and operates on ammonia as a working refrigerant therefor, and refrigerates and loops the coolant (600) to and from the independent coolant delivery systems (652 and 676) by the independent coolant paths (706 and 676) from there; and
the coolant (600) comprises D'Limonene.

11. A contact drum freezer system (500) comprising:
a hollow drum (540) mounted to revolve about an axis (668);
an endless product wrap belt (550) having an intake run (552), an inner food product-compressing run (556) encircling most of the drum (540) and an outer return run (554) looping back to the intake run (552); and
a feed apparatus (572) transferring unfrozen food product (580U) onto the intake run (552) of the product wrap belt (550);
wherein the drum (540) has an inside cylindrical surface (612) and an outer cylindrical surface (618);
the belt (550) has an infeed run (552), an inner food product-compressing run (556) and an outer return run (554) returning to the infeed run (552);
wherein the belt (550)'s inner food product-compressing run (556) forms an outer cylindrical surface and an inner cylindrical surface compressing food product (580) against the outer cylindrical surface (618) of the drum (540);
said contact drum freezer system (500) further comprises an INSIDE treatment system (602) for the hollow drum (540);
said contact drum freezer system (500) further comprises a coolant slinging system (652) which comprises a coolant slinger (702) turning about the central turning axis (668) inside the drum (540) to fling coolant (600) at the inside cylindrical surface (612) of the drum (540).

12. The contact drum freezer system (500) of claim 11, further comprising:
a first power-consuming device turning the drum (540) slowly on the turning axis (668); and
a second power-consuming device turning the coolant slinger (702) independently on the turning axis (688).

13. The contact drum freezer system (500) of claim 12, wherein:
the first and second power-consuming devices can turn the drum (540) and coolant slinger (702) in rotationally opposite directions (FIG. 4).

14. The contact drum freezer system (500) of claim 12, wherein:
the second and first power-consuming devices can turn the coolant slinger (702) rotationally faster than the drum (540), whereby coolant fluid (600) is thrown about three-hundred and sixty degrees (360°) inside the drum (540) at the inside cylindrical surface (612) of the drum.

15. The contact drum freezer system (500) of claim 14, further comprising:
a coolant storage tank (656) external of the drum (540), a pump (740) and coolant flow paths (706) for the INSIDE treatment system (602) looping the coolant fluid (600) among storage tank (656), pump (740) and coolant slinger (702) whereby the coolant fluid (600) is thrown about three-hundred and sixty degrees (360°) inside the drum (540) at the inside cylindrical surface (612) of the drum (540) before being looped back to the storage tank (656).

16. The contact drum freezer system (500) of claim 12, wherein the coolant slinger (702) comprises:
a turning cylindrical sidewall (FIG. 17);
a plurality of angularly-spaced axially-elongated nozzles (FIG. 14)); and
each nozzle provided with a paddle (756) for throwing the coolant fluid (600) about three-hundred and sixty degrees (360°) inside the drum (540) at the inside cylindrical surface (612) of the drum (540) (FIG. 4);
whereby the angular spacing among nozzle/paddle combinations (756) provides for separation of flow (pulsation), which not only creates a “pounding” of the coolant fluid (600) onto the inside surface (612) of the drum (540) but also gives the coolant fluid (600) time to flow away from the inside surface (612) of the drum (540) before a next wave comes along, thereby improving “in and out” flow of the coolant fluid (600) on the inside surface (612).

17. The contact drum freezer system (500) of claim 16, further comprising:
at least a pair of fanning fins (758) mounted on each paddle (756) to spread the flow the coolant fluid (600) axially across the width of the drum (540) (FIG. 14).

18-20. (canceled)
